(19) United States
(12) Patent Application Publication
(10) Pub. No.: US 2024/0355132 A1
(43) Pub. Date: Oct. 24, 2024

(54) VISION-BASED SYSTEM TRAINING WITH SIMULATED CONTENT

(71) Applicant: Tesla, Inc., Austin, TX (US)

(72) Inventors: Pengfei Phil Duan, Austin, TX (US); Nishant Desai, Austin, TX (US); Phillip Lee, Austin, TX (US)

(73) Assignee: Tesla, Inc., Austin, TX (US)

(21) Appl. No.: 18/684,589

(22) PCT Filed: Aug. 18, 2022
(86) PCT No.: PCT/US2022/040784

§ 371 Date: Feb. 16, 2024

Related U.S. Application Data
(60) Provisional application No. 63/260,439, filed on Aug. 19, 2021.
(60) Provisional application No. 63/287,936, filed on Dec. 9, 2021.

(51) Int. Cl. G06V 20/70; G06V 10/774; G06V 20/56

(52) U.S. Cl. CPC G06V 20/70; G06V 10/774; G06V 20/56

(57) ABSTRACT

Aspects of the present application correspond to utilization of a combined set of inputs to generate or train machine learned algorithms for utilization in vehicles with vision system-only based processing. A network service can receive a first set of inputs (e.g., a first data set) from a target vehicle including captured vision system data at a first point in time. The network service can receive a second set of inputs (e.g., a second data set) from the target vehicle including captured vision system data at a second point in time. The second point in time is subsequent to the first point in time. Based on the second set of ground truth labels and values, the network service can then determine or derive labels and associated values for the first set of ground truth labels and values.

### CROSS-REFERENCE TO RELATED APPLICATIONS

This application claims priority to U.S. Provisional Application No. 63/260,439 entitled ENHANCED SYSTEMS AND METHODS FOR AUTONOMOUS VEHICLE OPERATION AND TRAINING and filed on Aug. 19, 2021, and U.S. Provisional Application No. 63/287,936 entitled ENHANCED SYSTEMS AND METHODS FOR AUTONOMOUS VEHICLE OPERATION AND TRAINING and filed on Dec. 9, 2021. U.S. Provisional Application Nos. 63/260,439 and 63/287,936 are incorporated by reference in its entire herein.

### BACKGROUND

Generally described, computing devices and communication networks can be utilized to exchange data and/or information. In a common application, a computing device can request content from another computing device via the communication network. For example, a computing device can collect various data and utilize a software application to exchange content with a server computing device via the network (e.g., the Internet).

Generally described, a variety of vehicles, such as electric vehicles, combustion engine vehicles, hybrid vehicles, etc., can be configured with various sensors and components to facilitate operation of the vehicle or management of one or more systems include in the vehicle. In certain scenarios, a vehicle owner or vehicle user may wish to utilize sensor-based systems to facilitate in the operation of the vehicle. For example, vehicles can often include hardware and software functionality that facilitates location services or can access computing devices that provide location services. In another example, vehicles can also include navigation systems or access navigation components that can generate information related to navigational or directional information provided to vehicle occupants and users. In still further examples, vehicles can include vision systems to facilitate navigational and location services, safety services or other operational services/components.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 depicts a block diagram of an illustrative environment for generating simulated content models and training set data for vision systems in vehicles in accordance with one or more aspects of the present application;

FIG. 2A illustrates an environment that corresponds to vehicles in accordance with one or more aspects of the present application;

FIG. 2B an illustrative vision system for a vehicle in accordance with one or more aspects of the present application;

FIG. 3 depicts an illustrative architecture for implementing a vision information processing component in accordance with aspects of the present application,

FIGS. 4A-4B are block diagrams of the illustrative environment of FIG. 1 illustrated the generation of vision system training data for machine learning algorithms based on simulate model content; and

FIG. 5 is a flow diagram illustrative of a simulated model content generation routine implemented by a simulated content service in accordance with illustrative embodiments.

### DETAILED DESCRIPTION

Generally described, one or more aspects of the present disclosure relate to the configuration and implementation of vision systems in vehicles. By way of illustrative example, aspects of the present application relate to the configuration and training of machine learned algorithms used in vehicles relying solely on vision systems for various operational functions. More specifically, aspects of the present application relate to the utilization of sets of captured vision system data to facilitate the automated generation of ground truth labels. Illustratively, the vision-only systems are in contrast to vehicles that may combine vision-based systems with one or more additional sensor systems, such as radar-based systems, LIDAR-based systems, SONAR-systems, and the like.

Vision-only systems can be configured with machine learned algorithms that can process inputs solely from vision systems that can include a plurality of cameras mounting on the vehicle. The machine learned algorithm can generate outputs identifying objects and specifying characteristics/attributes of the identified objects, such as position, velocity, acceleration measured relative to the vehicle. The outputs from the machine learned algorithms can be then utilized for further processing, such as for navigational systems, locational systems, safety systems and the like.

In accordance with aspects of the present application, a network service can configure the machine learned algorithm in accordance with a supervised learning model in which a machine learning algorithm is trained with training sets that include captured vision system information and labeled data including identified objects and specified characteristics/attributes, such as position, velocity, acceleration, and the like. Traditional approaches to generation of the training data sets and training of the machine learning algorithms to form the machine learned algorithms often require a manual determination of ground truth labels and associated values for captured vision system information. Such manual approaches are not well suited for larger scale implementation in which the captured vision system data can corresponds to large amounts of individual captured data to be processed. Automated approaches to generating ground truth label data for captured vision system data can be inefficient based on often incomplete or ambiguous image data in each individually captured vision system frame (or set of frames). For example, a particular frame of captured vision system data may have multiple potential interpretations for detected objects and attributes values, such as positioning (e.g., yaw), distance, velocity, etc. Accordingly, some automated systems can include the need for additional sensors/inputs, such as RADAR, LIDAR or other detection systems, to confirm or identify objects and associated attributes/values.

Illustratively, a network service can receive a first set of inputs (e.g., a first data set) from a target vehicle including captured vision system data at a first point in time. The network service then processes at least the ground truth label data associated with the captured vision system data to determine an initial set of ground truth labels and values. The network service can receive a second set of inputs (e.g., a second data set) from the target vehicle including captured vision system data at a second point in time. The second point in time is subsequent to the first point in time. The network service then processes at least the ground truth label data associated with the captured vision system data to determine a second set of ground truth labels and values.

Based on the second set of ground truth labels and values, the network service can then determine labels and associated values for the first set of ground truth labels and values. More specifically, the network service can utilize the known ground truth labels and values resulting of the later point in time to determine or update what the processing of the vision system data of the earlier point of time should have been. For example, ground truth data at the first instance that related multiple potential directional attributes (e.g., yaw rate) would be resolved to the appropriate yaw rate that results in the appropriate end location. In another example, ground truth label values related to positional calculated values for detected objects can be resolved based on determination of positional values in the second point of time.

Illustratively, the generated data sets allows the supplementing of the previously collected ground truth data/vision data with additional information or attribute/characteristics that may not have been otherwise available from originally processing the vision data. The resulting processed content attributes can then form the basis for subsequent generation of training data. The network service can then process the full set of vision data and generated content with data labels. Thereafter, the network service generates an updated machine learned algorithm based on training on the combined data set. The trained machine learned algorithm may be transmitted to vision-only based vehicles.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of vehicles including vehicles with different of propulsion systems, such as combination engines, hybrid engines, electric engines, and the like. Still further, aspects of the present application may be applicable with various types of vehicles that can incorporate different types of sensors, sensing systems, navigation systems, or location systems. Accordingly, the illustrative examples should not be construed as limiting. Similarly, aspects of the present application may be combined with or implemented with other types of components that may facilitate operation of the vehicle, including autonomous driving applications, driver convenience applications and the like.

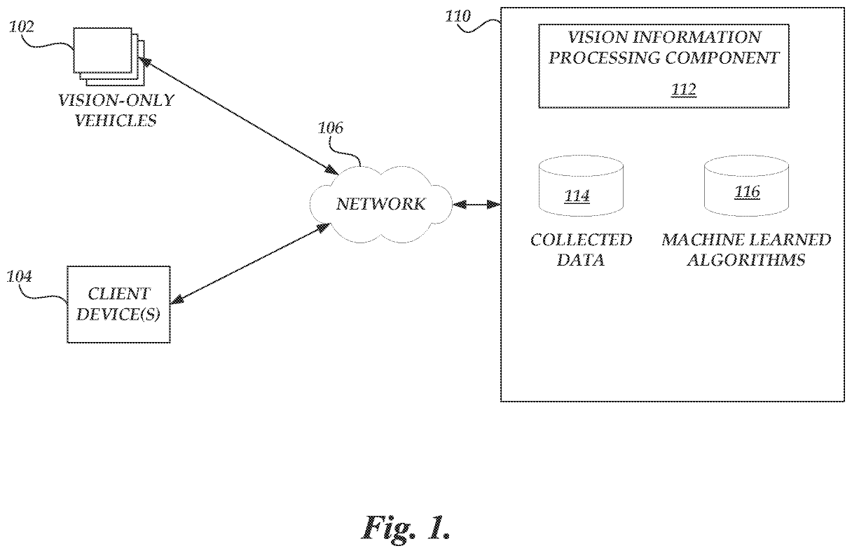

FIG. 1 depicts a block diagram of an illustrative environment 100 for generating simulated content models and training set data for vision systems in vehicles in accordance with one or more aspects of the present application. The system 100 can comprise a network, the network connecting a set of vehicles 102, one or more additional client devices 104, and a network service 110. Illustratively, the various aspects associated with the network service 110 can be implemented as one or more components that are associated with one or more functions or services. The components may correspond to software modules implemented or executed by one or more external computing devices, which may be separate stand-alone external computing devices. Accordingly, the components of the network service 110 should be considered as a logical representation of the service, not requiring any specific implementation on one or more external computing devices.

Network 106, as depicted in FIG. 1, connects the devices and modules of the system. The network can connect any number of devices. In some embodiments, a network service provider provides network-based services to client devices via a network. A network service provider implements network-based services and refers to a large, shared pool of network-accessible computing resources (such as compute, storage, or networking resources, applications, or services), which may be virtualized or bare-metal. The network service provider can provide on-demand network access to a shared pool of configurable computing resources that can be programmatically provisioned and released in response to customer commands. These resources can be dynamically provisioned and reconfigured to adjust to the variable load. The concept of “cloud computing” or “network-based computing” can thus be considered as both the applications delivered as services over the network and the hardware and software in the network service provider that provide those services. In some embodiments, the network may be a content delivery network.

Illustratively, the set of vehicles 102 correspond to one or more vehicles configured with vision-only based system for identifying objects and characterizing one or more attributes of the identified objects. The set of vehicles 102 are configured with machine learned algorithms, such as machine learned algorithms implemented a supervised learning model, that are configured to utilize solely vision systems inputs to identify objects and characterize attributes of the identified objects, such as position, velocity and acceleration attributes. The set of vehicles 102 may be configured without any additional detection systems, such as radar detection systems, LIDAR detection systems, and the like.

Illustratively, the network service 110 can include a plurality of network-based services that can provide functionality responsive to configurations/requests for machine learned algorithms for vision-only based systems as applied to aspects of the present application. As illustrated in FIG. 1, the network-based services 110 can include a vision information processing component 112 that can obtain data sets from the vehicles 102 an, process sets of data to form training materials for machine learning algorithm and generate machine learned algorithms for vision-only based vehicles 102. The network-based service can include a plurality of data stores for maintaining various information associated with aspects of the present application, including a vehicle data store 114 and machine learned algorithm data store 116. The data stores in FIG. 1 are logical in nature and can be implemented in the network service 110 in a variety of manners.

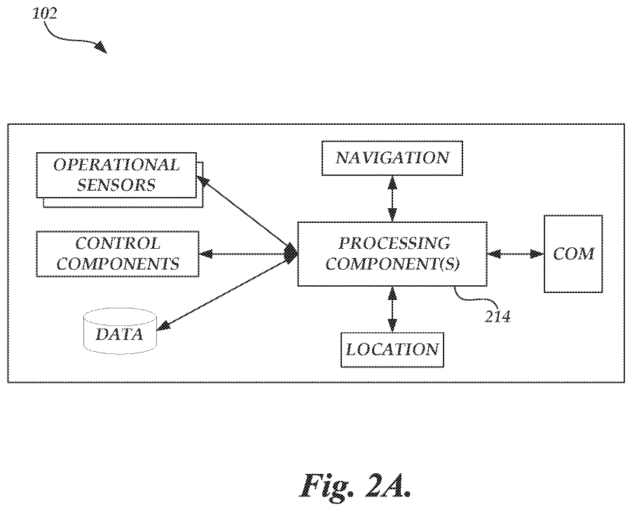

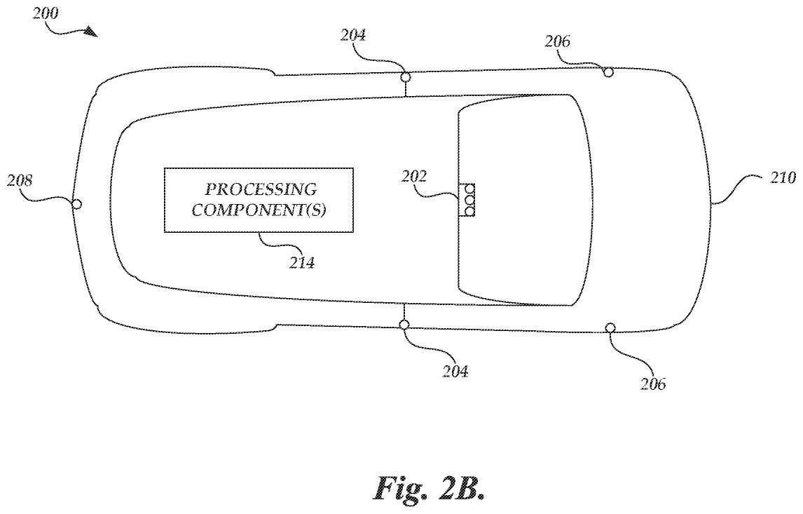

For purposes of illustration, FIG. 2A illustrates an environment that corresponds to vehicles 102 in accordance with one or more aspects of the present application. The environment includes a collection of local sensor inputs that can provide inputs for the operation of the vehicle or collection of information as described herein The collection of local sensors can include one or more sensor or sensor-based systems included with a vehicle or otherwise accessible by a vehicle during operation. The local sensors or sensor systems may be integrated into the vehicle. Alternatively, the local sensors or sensor systems may be provided by interfaces associated with a vehicle, such as physical connections, wireless connections, or a combination thereof.

In one aspect, the local sensors can include vision systems that provide inputs to the vehicle, such as detection of objects, attributes of detected objects (e.g., position, velocity, acceleration), presence of environment conditions (e.g., snow, rain, ice, fog, smoke, etc.), and the like. An illustrative collection of cameras mounted on a vehicle to form a vision system will be described with regard to FIG. 2B. As previously described, vehicles 102 will rely on such vision systems for defined vehicle operational functions without assistance from or in place of other traditional detection systems.

In yet another aspect, the local sensors can include one or more positioning systems that can obtain reference information from external sources that allow for various levels of accuracy in determining positioning information for a vehicle. For example, the positioning systems can include various hardware and software components for processing information from GPS sources, Wireless Local Area Networks (WLAN) access point information sources, Bluetooth information sources, radio-frequency identification (RFID) sources, and the like. In some embodiments, the positioning systems can obtain combinations of information from multiple sources. Illustratively, the positioning systems can obtain information from various input sources and determine positioning information for a vehicle, specifically elevation at a current location. In other embodiments, the positioning systems can also determine travel-related operational parameters, such as direction of travel, velocity, acceleration, and the like. The positioning system may be configured as part of a vehicle for multiple purposes including self-driving applications, enhanced driving or user-assisted navigation, and the like. Illustratively, the positioning systems can include processing components and data that facilitate the identification of various vehicle parameters or process information.

In still another aspect, the local sensors can include one or more navigations system for identifying navigation related information. Illustratively, the navigation systems can obtain positioning information from positioning systems and identify characteristics or information about the identified location, such as elevation, road grade, etc. The navigation systems can also identify suggested or intended lane location in a multi-lane road based on directions that are being provided or anticipated for a vehicle user. Similar to the location systems, the navigation system may be configured as part of a vehicle for multiple purposes including self-driving applications, enhanced driving or user-assisted navigation, and the like. The navigation systems may be combined or integrated with positioning systems. Illustratively, the positioning systems can include processing components and data that facilitate the identification of various vehicle parameters or process information.

The local resources further include one or more processing component(s) 214 that may be hosted on the vehicle or a computing device accessible by a vehicle (e.g., a mobile computing device). The processing component(s) can illustratively access inputs from various local sensors or sensor systems and process the inputted data as described herein. For purposes of the present application, the processing component(s) will be described with regard to one or more functions related to illustrative aspects. For example, processing component(s) in vehicles 102 will collect and transmit the first data set corresponding to the collected vision information.

The environment can further include various additional sensor components or sensing systems operable to provide information regarding various operational parameters for use in accordance with one or more of the operational states. The environment can further include one or more control components for processing outputs, such as transmission of data through a communications output, generation of data in memory, transmission of outputs to other processing components, and the like.

With reference now to FIG. 2B, an illustrative vision system 200 for a vehicle will be described. The vision system 200 includes a set of cameras that can capture image data during the operation of a vehicle. As described above, individual image information may be received at a particular frequency such that the illustrated images represent a particular time stamp of images. In some embodiments, the image information may represent high dynamic range (HDR) images. For example, different exposures may be combined to form the HDR images. As another example, the images from the image sensors may be pre-processed to convert them into HDR images (e.g., using a machine learning model).

As illustrated in FIG. 2B, the set of cameras can include a set of front facing cameras 202 that capture image data. The front facing cameras may be mounted in the windshield area of the vehicle to have a slightly higher elevation. As illustrated in FIG. 2B, the front facing cameras 202 can including multiple individual cameras configured to generate composite images. For example, the camera housing may include three image sensors which point forward. In this example, a first of the image sensors may have a wide-angled (e.g., fish-eye) lens. A second of the image sensors may have a normal or standard lens (e.g., 35 mm equivalent focal length, 50 mm equivalent, and so on). A third of the image sensors may have a zoom or narrow lens. In this way, three images of varying focal lengths may be obtained in the forward direction by the vehicle. The vision system 200 further includes a set of cameras 204 mounted on the door pillars of the vehicle. The vision system 200 can further include two cameras 206 mounted on the front bumper of the vehicle. Additionally, the vision system 200 can include a rearward facing camera 208 mounted on the rear bumper, trunk or license plate holder.

The set of cameras 202, 204, 206, and 208 may all provide captured images to one or more processing components 214, such as a dedicated controller/embedded system. For example, the processing component 214 may include one or more matrix processors which are configured to rapidly process information associated with machine learning models. The processing component 212 may be used, in some embodiments, to perform convolutions associated with forward passes through a convolutional neural network. For example, input data and weight data may be convolved. The processing component 212 may include a multitude of multiply-accumulate units which perform the convolutions. As an example, the matrix processor may use input and weight data which has been organized or formatted to facilitate larger convolution operations. Alternatively, the image data may be transmitted to a general-purpose processing component.

Illustratively, the individual cameras may operate, or be considered individually, as separate inputs of visual data for processing. In other embodiments, one or more subsets of camera data may be combined to form composite image data, such as the trio of front facing cameras 202. As further illustrated in FIG. 2B, in embodiments related to vehicles incorporating vision only systems, such as vehicles 102, no detection systems would be included at 210.

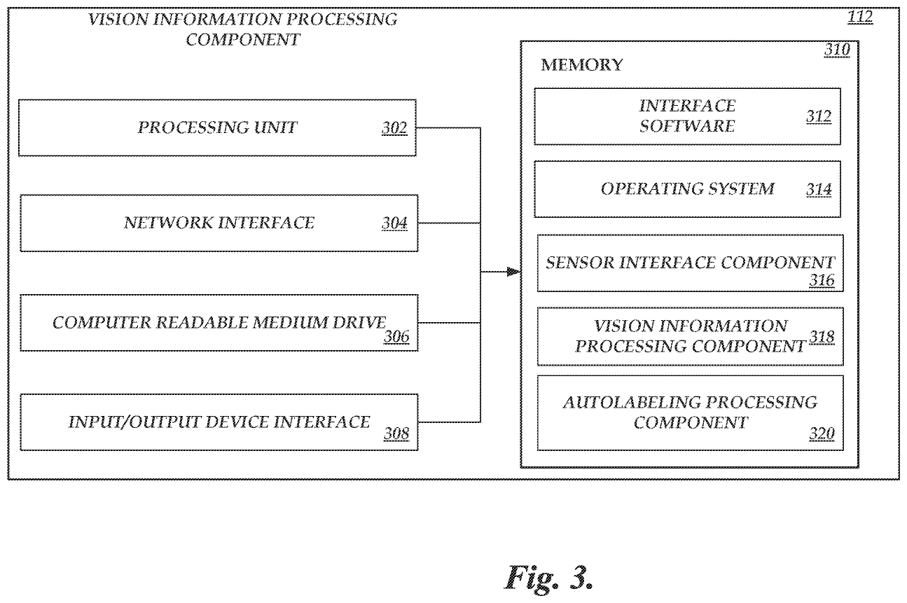

With reference now to FIG. 3, an illustrative architecture for implementing the vision information processing component 112 on one or more local resources or a network service will be described. The vision information processing component 112 may be part of components/systems that provide functionality associated with the machine learned algorithms for object recognition, navigation, locations services, and the like.

The architecture of FIG. 3 is illustrative in nature and should not be construed as requiring any specific hardware or software configuration for the vision information processing component 112. The general architecture of the vision information processing component 112 depicted in FIG. 3 includes an arrangement of computer hardware and software components that may be used to implement aspects of the present disclosure. As illustrated, the vision information processing component 112 includes a processing unit 302, a network interface 304, a computer readable medium drive 306, and an input/output device interface 308, all of which may communicate with one another by way of a communication bus. The components of the vision information processing component 112 may be physical hardware components or implemented in a virtualized environment.

The network interface 304 may provide connectivity to one or more networks or computing systems, such as the network of FIG. 1. The processing unit 302 may thus receive information and instructions from other computing systems or services via a network. The processing unit 302 may also communicate to and from memory 310 and further provide output information for an optional display (not shown) via the input/output device interface 308. In some embodiments, the vision information processing component 112 may include more (or fewer) components than those shown in FIG. 3.

The memory 310 may include computer program instructions that the processing unit 302 executes in order to implement one or more embodiments. The memory 310 generally includes RAM, ROM, or other persistent or non-transitory memory. The memory 310 may store interface software 312 and an operating system 314 that provides computer program instructions for use by the processing unit 302 in the general administration and operation of the vision information processing component 112. The memory 310 may further include computer program instructions and other information for implementing aspects of the present disclosure. For example, in one embodiment, the memory 310 includes a sensor interface component 316 that obtains information (e.g., captured video information) from vehicles, such as vehicles 102, data stores, other services, and the like.

The memory 310 further includes a vision information processing component 318 for obtaining and processing the captured vision system information and generating additional or alternative ground truth label information for the captured vision information in accordance with various operational states of the vehicle as described herein. The memory 310 can further include an auto labeling processing component 320 for automatically generating labels for use in training machine learned algorithms as described herein. Illustratively, in one embodiment, the vision information processing component 112 can train a number of machine learned algorithms, such as for static object detection, dynamic object detection, and the like.

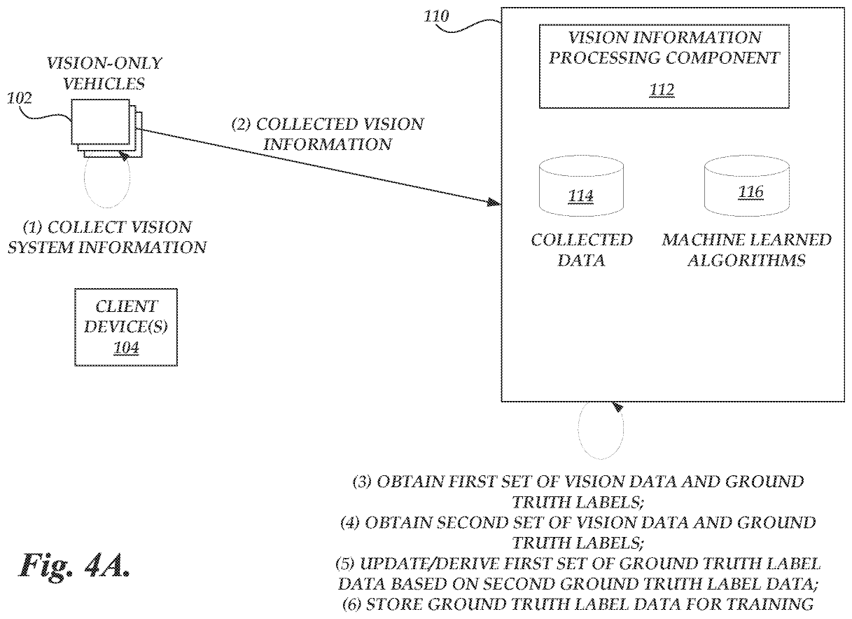

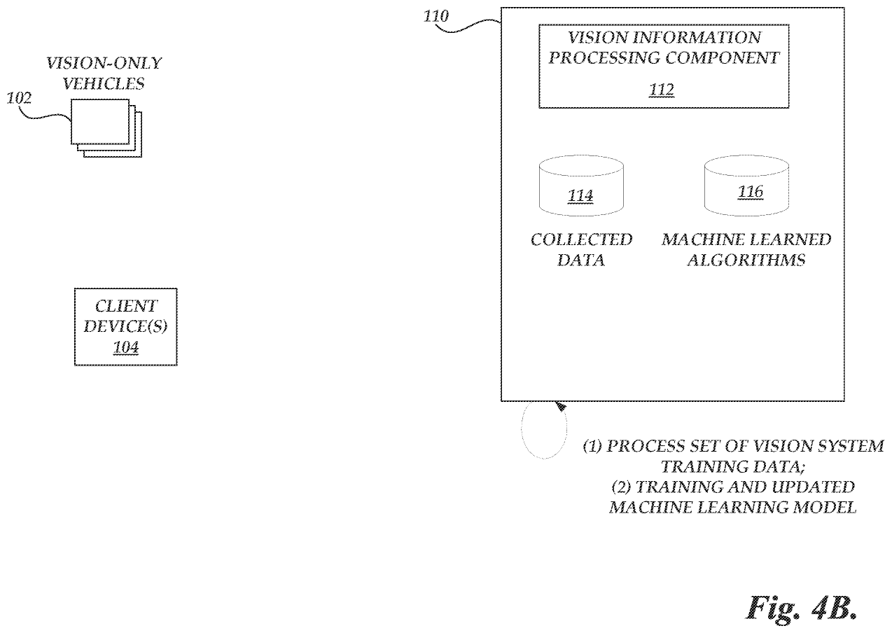

Turning now to FIGS. 4A-4B, illustrative interactions for the components of the environment to process vision system data and generate simulated content system data to update training models for machine learning algorithms will be described. At (1), one or more vehicles 102 can collect and transmit a set of inputs (e.g., the first data set). The first set of data illustratively corresponds to the video image data and any associated metadata or other attributes collected by the vision system 200 of the vehicle 102.

Illustratively, the vehicles 102 may be configured to collect vision system data and transmit the collected data. Illustratively, the vehicles 102 may include processing capabilities in vision systems to generate, at least in part, ground truth label information for the captured vision system information. In other embodiments, the vehicles 102 may transmit captured vision system information (with or without any ground truth labels) to another service, such as in the network 110. The additional services can then add (manually or automatically) ground truth label information. For example, the collected vision system data may be transmitted based on periodic timeframes or various collection/transmission criteria. Still further, in some embodiments, the vehicles 102 may also be configured to identify specific scenarios or locations, such as via geographic coordinates or other identifiers, that will result in the collection and transmission of the collected data.

Illustratively, the network service receives and processes the collected vision system data and ground truth labels from the vehicles 102. More specifically, at (3), a network service can receive a first set of inputs (e.g., a first data set) from a target vehicle including captured vision system data at a first point in time. The network service then processes at least the ground truth label data associated with the captured vision system data to determine an initial set of ground truth labels and values. The processed first captured vision system data at a first point in time can form an initial set of ground truth labels and values that can include one or more indeterminate values or multiple possible values. The generation of the first set of ground truth label data may be based on one or more machine learned algorithms.

At (4) network service can receive a second set of inputs (e.g., a second data set) from the target vehicle including captured vision system data at a second point in time. The second point in time is subsequent to the first point in time. In one embodiment, the capture of the first and second vision system data can be based on a frequency of capture. For example, the vision systems of the vehicle 102 may capture based on frequency of capture of 20 Hz, 21 Hz, 22 Hz, 23 Hz, 24 Hz, 25 Hz, 26 Hz, 27 Hz, 28 Hz, 29 Hz, 30 Hz, 40 Hz (and all intervening values in between); 50 Hz (and all intervening values therein), 60 Hz (and all intervening values therein), 70 Hz (and all intervening values therein), 80 Hz (and all intervening values therein), 90 Hz (and all intervening values therein), and the like. The network service then processes at least the ground truth label data associated with the captured vision system data to determine a second set of ground truth labels and values.

At (5), based on the second set of ground truth labels and values, the network service can then determine labels and associated values for the first set of ground truth labels and values. More specifically, the network service can utilize the known ground truth labels and values resulting of the later point in time to determine or update what the processing of the vision system data of the earlier point of time should have been. For example, ground truth data at the first instance that related multiple potential directional attributes (e.g., yaw rate) would be resolved to the appropriate yaw rate that results in the appropriate end location. In another example, ground truth label values related to positional calculated values for detected objects can be resolved based on determination of positional values in the second point of time. In this embodiment, the network service is illustratively deriving or validating the ground truth labels and values for the first set of data by using the known results provided by the second set of captured video data. The specific process for deriving the values can be based on the type of ground truth label data. For example, deriving positional estimates for detection object(s) can be based on the measured positional values for the detected object in the second set of captured vision data (e.g., actual location). In another example, deriving velocity estimates can be based on calculating positional data and expired time in the second set of captured vision data. In still other embodiments, the deriving identification of static objects or dynamic objects can be based on matching or updating the identified static object or dynamic object from the second set of captured vision data. Accordingly, one skilled in the relevant art will appreciate that various techniques may be applied for the first and second set of vision data at (5).

At (6), the resulting ground truth labels and values may be stored. Additionally, the labels and values may be transmitted or otherwise made available to additional services.

Turning now to FIG. 4B, once the vision information processing component 112 vision information processing component 112 receives the training set, at (1) the network service 110 processes the training sets. At (2), the vision information processing component 112 generates an updated machine learned algorithm based on training on the combined data set. Illustratively, the network service 110 can utilize a variety of machine learning models to generate updated machine learned algorithms.

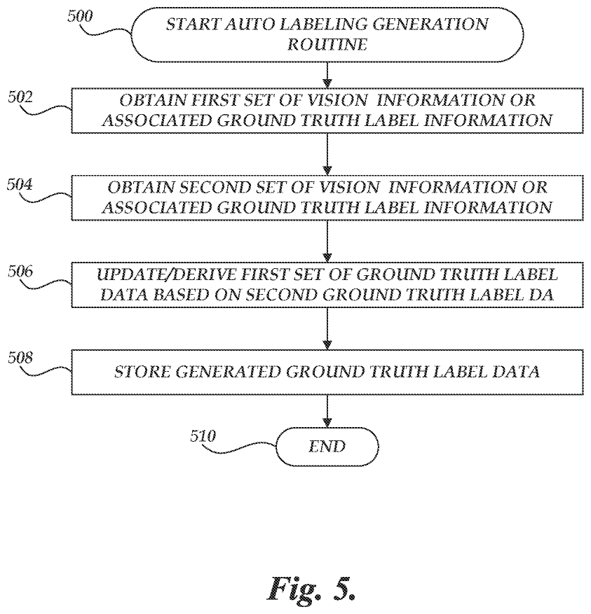

Turning now to FIG. 5, a routine 500 for processing collected vision for providing auto labeling will be described. Routine 500 is illustratively implemented by the vision information processing component 112. As described above, routine 500 may be implemented after the target vehicle(s) 102 including vision system data and ground truth label data for the captured vision system data is available for processing. Illustratively, the vehicles 102 may be configured to collect vision system data and transmit the collected data and associated ground truth labels. For example, the collected vision system data may be transmitted based on periodic timeframes or various collection/transmission criteria. Still further, in some embodiments, the vehicles 102 may also be configured to identify specific scenarios or locations, such as via geographic coordinates or other identifiers, that will result in the collection and transmission of the collected data. In other embodiments, the vehicles 102 may transmit captured vision system information (with or without any ground truth labels) to another service, such as in the network 110. The additional services can then add (manually or automatically) ground truth label information. Illustratively, the vision information processing component 112 receives and processes the collected vision system data and ground truth labels from the vehicles 102.

More specifically, at block 502, the vision information processing component 112 can receive a first set of inputs (e.g., a first data set) from a target vehicle including captured vision system data at a first point in time. The network service then processes at least the ground truth label data associated with the captured vision system data to determine an initial set of ground truth labels and values. The processed first captured vision system data at a first point in time can form an initial set of ground truth labels and values that can include one or more indeterminate values or multiple possible values. The generation of the first set of ground truth label data may be based on one or more machine learned algorithms.

At block 504, the vision information processing component 112 can receive a second set of inputs (e.g., a second data set) from the target vehicle including captured vision system data at a second point in time. The second point in time is subsequent to the first point in time. In one embodiment, the capture of the first and second vision system data can be based on a frequency of capture. For example, the vision systems of the vehicle 102 may capture based on frequency of capture of 20 Hz (and all intervening values therein), 30 Hz (and all intervening values therein), 40 Hz (and all intervening values in between); 50 Hz (and all intervening values therein), 60 Hz (and all intervening values therein), 70 Hz (and all intervening values therein), 80 Hz (and all intervening values therein), 90 Hz (and all intervening values therein), and the like. The vision information processing component 112 then processes at least the ground truth label data associated with the captured vision system data to determine a second set of ground truth labels and values.

At block 506, based on the second set of ground truth labels and values, the vision information processing component 112 can then determine labels and associated values for the first set of ground truth labels and values. More specifically, the network service can utilize the known ground truth labels and values resulting of the later point in time to determine or update what the processing of the vision system data of the earlier point of time should have been. For example, ground truth data at the first instance that related multiple potential directional attributes (e g., yaw rate) would be resolved to the appropriate yaw rate that results in the appropriate end location. In another example, ground truth label values related to positional calculated values for detected objects can be resolved based on determination of positional values in the second point of time. In this embodiment, the network service is illustratively deriving or validating the ground truth labels and values for the first set of data by using the known results provided by the second set of captured video data. The specific process for deriving the values can be based on the type of ground truth label data. For example, deriving positional estimates for detection object(s) can be based on the measured positional values for the detected object in the second set of captured vision data (e.g., actual location). In another example, deriving velocity estimates can be based on calculating positional data and expired time in the second set of captured vision data. In still other embodiments, the deriving identification of static objects or dynamic objects can be based on matching or updating the identified static object or dynamic object from the second set of captured vision data. Accordingly, one skilled in the relevant art will appreciate that various techniques may be applied for the first and second set of vision data at block 506.

At block 508, the resulting ground truth labels and values may be stored. Additionally, the labels and values may be transmitted or otherwise made available to additional services. Routine 500 terminates at block 510. As described above, the vision information processing component 112 generates an updated machine learned algorithm based on training on the combined data set. Illustratively, the vision information processing component 112 can utilize a variety of machine learning models to generate updated machine learned algorithms. For example, multiple machine learned algorithms may be formed based on types of detected object or ground truth labels.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed decision and control algorithms. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer those two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed:

1. A system for managing vision systems in vehicles, the system comprising:
a plurality of vehicles including systems for generating and processing vision data captured from one or more vision systems according to at least one machine learned algorithm, wherein the vision data captured from one or more vision systems is associated with ground truth labels;
one or more computing systems including processing devices and memory, that execute computer-executable instructions, for implementing a vision system information processing component that is operative to generate the at least one machine learned algorithm for execution by the plurality of vehicles, the at least one machine learned algorithm generated from a set training data; and
one or more computing systems including processing devices and memory, that execute computer-executable instructions, for implementing a vision system processing service operative to:
obtain first vision system capture information associated with images captured in the operation of a vehicle, the first vision system capture information associated with a first instance of time;
obtain second vision system capture information associated with images captured in the operation of the vehicle, the second vision system capture information associated with a second instance of time, the second instance of time subsequent to the first instance of time;
obtain ground truth data labels and values associated with the second vision system capture information;
at least one of determine or update ground truth data labels and values associated with the first vision system capture information based on the obtained ground truth data labels and values associated with the second vision system capture information; and

2. store a set of ground truth labels and values for the first and second instance of time. The system as recited in claim 1, wherein the first and second ground truth data labels and values correspond to velocity.

3. The system as recited in claim 1, wherein the first and second ground truth data labels and values correspond to yaw.

4. The system as recited in claim 1, wherein the first and second ground truth data labels and values correspond to position for detected objects.

5. The system as recited in claim 1, wherein the vision system processing service operative to determine an initial set of ground truth data labels and values associated with the first vision system capture information prior to obtaining the ground truth data labels and values associated with the second vision system capture information.

6. The system as recited in claim 1, wherein the vision system processing service operative to determine the ground truth data labels and values associated with the second vision system capture information.

7. A method for managing vision systems in vehicles, the system comprising:
obtaining first vision system capture information associated with images captured in the operation of a vehicle, the first vision system capture information associated with a first instance of time;
obtaining second vision system capture information associated with images captured in the operation of the vehicle, the second vision system capture information associated with a second instance of time, the second instance of time subsequent to the first instance of time;
obtaining ground truth data labels and values associated with the second vision system capture information;
at least one of determining or updating ground truth data labels and values associated with the first vision system capture information based on the obtained ground truth data labels and values associated with the second vision system capture information; and

8. storing a set of ground truth labels and values for the first and second instance of time. The method as recited in claim 7, wherein the first and second ground truth data labels and values correspond to velocity.

9. The method as recited in claim 7, wherein the first and second ground truth data labels and values correspond to yaw.

10. The method as recited in claim 7, wherein the first and second ground truth data labels and values correspond to position for detected objects.

11. The method as recited in claim 7 further comprising determining an initial set of ground truth data labels and values associated with the first vision system capture information prior to obtaining the ground truth data labels and values associated with the second vision system capture information.

12. The method as recited in claim 7, further comprising determining the ground truth data labels and values associated with the second vision system capture information.

13. The method as recited in claim 7, wherein obtaining first vision system capture information associated with images captured in the operation of a vehicle, the first vision system capture information associated with a first instance of time and obtaining second vision system capture information associated with images captured in the operation of the vehicle, the second vision system capture information associated with a second instance of time, the second instance of time subsequent to the first instance of time is based on a capture rate.

14. The method as recited in claim 13, wherein the capture rate is 24 hertz.

15. A method for managing vision systems in vehicles, the system comprising:
obtaining ground truth data labels and values associated with first and second vision system capture information, wherein the first vision system capture information associated with a first instance of time and wherein the second vision system capture information associated with a second instance of time, the second instance of time subsequent to the first instance of time;
updating ground truth data labels and values associated with the first vision system capture information based on the obtained ground truth data labels and values associated with the second vision system capture information; and

16. storing a set of ground truth labels and values for the first and second instance of time. The method as recited in claim 15, wherein the first and second ground truth data labels and values correspond to at least one of velocity, yaw, or position for detected objects.

17. The method as recited in claim 15 further comprising determining an initial set of ground truth data labels and values associated with the first vision system capture information prior to obtaining the ground truth data labels and values associated with the second vision system capture information.

18. The method as recited in claim 15 further comprising determining the ground truth data labels and values associated with the second vision system capture information.

19. The method as recited in claim 15 further comprising obtaining first vision system capture information associated with images captured in the operation of a vehicle.

20. The method as recited in claim 19 further comprising obtaining second vision system capture information associated with images captured in the operation of the vehicle, the second vision system capture information based on a capture rate.
